(19) United States
(12) Patent Application Publication
(10) Pub. No.: US 2008/0037501 A1
(43) Pub. Date: Feb. 14, 2008

(54) Managing mobility of different communication technologies

(76) Inventors: Rashad Mohammad Ali, Plano, TX (US); Pulin R. Patel, McKinney, TX (US); Mahbubul Alam, McKinney, TX (US)

Correspondence Address: FISH & RICHARDSON P.C., P.O. BOX 1022, MINNEAPOLIS, MN, 55440-1022, US

(21) Appl. No.: 11/504,251

(22) Filed: Aug. 14, 2006

(51) Int. Cl. H04B 7/216

(52) U.S. Cl. 370/342

(57) ABSTRACT

The present disclosure provides a system and method for managing wireless devices. In some embodiments, a communications network includes a network plane having a core network. An access plane includes a radio access network (RAN) and a broadband network. A node is located at an edge of the access plane. The node is operable to provide inter-access handover between a cellular technology and a broadband technology for data sessions with multi-mode mobile devices.

### TECHNICAL FIELD

This invention relates to network management and, more particularly, to managing mobility of different communication technologies.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

The present disclosure provides a system and method for managing wireless devices. In some embodiments, a communications network includes a network plane having a core network. An access plane includes a radio access network (RAN) and a broadband network. A node is located at an edge of the access plane. The node is operable to provide inter-access handover between a cellular technology and a broadband technology for data sessions with multi-mode mobile devices.

Technical advantages of the present invention include providing an improved method and system for providing handovers between a cellular radio technology and a broadband technology. For example, an improved system for switching between GSM-based technology and SIP-based technology. In some embodiments, a cellular call leg and a broadband leg may be seamlessly switched while maintaining continuity of a call session. In some embodiments, IMS services may be provided on a cellular device.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a communication system for managing dual-mode wireless devices;

FIGS. 2A to 2D is a block diagram illustrating handovers in the communication system of FIG. 1 in accordance with one embodiment of the present disclosure;

FIG. 3 is an example dual-mode wireless device of FIG. 1 in accordance with one embodiment of the present disclosure;

FIG. 4 is an example communication node of FIG. 1 for managing handovers between different communication technologies;

FIG. 5 is an example call engine of FIG. 4 for providing call control functionality for call sessions in communication system of FIG. 1;

FIGS. 6A to 6F illustrate example call flows in accordance with communication system of FIGS. 1; and

FIGS. 7A to 7E illustrate example methods for managing calls in communication system of FIG. 1.

Like reference symbols in the various drawings indicate like elements.

### DETAILED DESCRIPTION

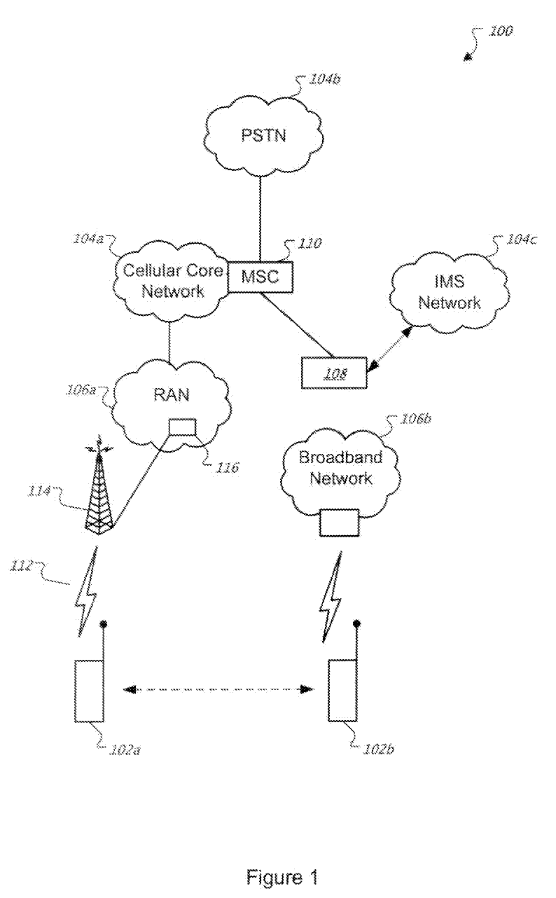

FIG. 1 is a block diagram illustrating communication system 100 for managing dual-mode wireless devices 102 during handovers between different wireless access networks. In general, a dual-mode device is a device operable use two or more different communication technologies. For example, the two modes may be a cellular radio technology and a broadband technology. Cellular radio technologies include Global System for Mobile Communication (GSM) protocols, Code Division Multiple Access (CDMA) protocols, Universal Mobile Telecommunications System (UMTS), and/or any other suitable protocol for formatting data for cellular communication. Broadband technologies include Session Inititiaon Protocol (SIP), Unlicensed Mobile Access (UMA), proprietary protocols, and any other suitable protocols for formatting data for broadband communication. For example, broadband technologies may include communication system operable to transmit data greater than 64 kilobits/second (Kbps). In some embodiments, broadband technologies may include communication system operable to transmit data greater than 256 Kbps. In some embodiments, the width of a broadband channel is 20 KHz or greater. In some embodiments, system 100 enables mobile devices 102 to switch between a cellular-radio-technology mode and a broadband-technology mode. In doing so, mobile devices 102 may switch between accessing services from core networks 104 through two different access networks 106. For example, mobile device 102 may include a GSM mode and a SIP mode enabling mobile device 102 to access services either through Radio Access Network (RAN) 106a or broadband network 106b. In some embodiments, system 100 enables seamless switching between modes during a communication session. A communication session may be a call, data, video, audio, multimedia or other session in which information and requests are exchanged. As a result, the switching performed by system 100 may provide voice call continuity during a handover between different communication access technologies.

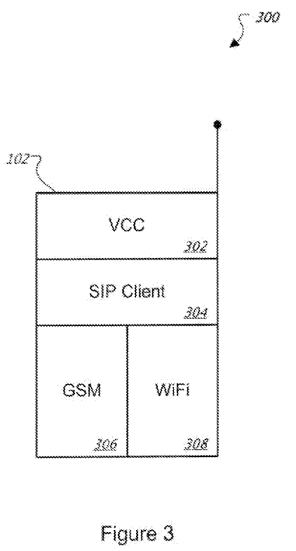

At a high level, system 100 includes mobile devices 102, core networks 104, access networks 106, and communication node 108. Each mobile device 102 comprises an electronic device operable to receive and transmit wireless communication with system 100. As used in this disclosure, mobile devices 110 are intended to encompass cellular phones, data phones, pagers, portable computers, smart phones, personal data assistants (PDAs), one or more processors within these or other devices, or any other suitable processing devices capable of communicating information over a wireless link to access networks 106. In the illustrated embodiment, mobile devices 102 is able to transmit in multiple bands such as in the cellular band and WiFi band. In these cases, messages transmitted and/or received by mobile device 102 may be based on a cellular radio technology and/or a broadband technology. Conventionally, special handsets are required for operating in a dual-mode using a cellular radio technology and UMA. In this case, conventional 2G and 3G systems, while some are operable to transmit in the WiFi band, need additional hardware and updates to call processing software to fully operate using UMA. As a result, substantial expense and effort would be needed to fully convert such 2G and 3G systems to fully operational dual-mode systems. In contrast, a software client (discussed in FIG. 3) may be added to such 2G and 3G systems enabling them to operate in the SIP mode and access broadband network 106b. In addition, mobile device 102 operating in SIP mode may directly access some core networks 104 without requiring any type of translation, modification, or conversion of messages between mobile device 102 and the particular core network 104. Generally, the mobile devices 102 may transmit voice, video, multimedia, text, web content or any other user/client-specific content. In short, device 102 generates requests, responses or otherwise communicates with core networks 104 via access networks 106.

In the illustrated embodiment, core networks 104 include cellular core network 104a, PSTN 104b, and IMS network 104c. Cellular core network 104a typically includes various switching elements and gateways for providing cellular services. Cellular core network 104 often provides these services via a number of RANs, such as RAN 106a, and also interfaces the cellular system with other communication systems such as PSTN 104b via mobile switching center (MSC) 110. In accordance with the GSM standard, cellular core network 104a includes a circuit switched (or voice switching) portion for processing voice calls and a packet switched (or data switching) portion for supporting data transfers such as, for example, e-mail messages and web browsing. The circuit switched portion includes MSC 110 that switches or connects telephone calls between RAN 106a and PSTN 104b or other network. The packet-switched portion, also known as General Packet Radio Service (GPRS), includes a Serving GPRS Support Node (SGSN) (not illustrated), similar to MSC 110, for serving and tracking mobile devices 102, and a Gateway GPRS Support Node (GGSN) (not illustrated) for establishing connections between packet-switched networks and mobile devices 102. The SGSN may also contain subscriber data useful for establishing and handing over call connections. Cellular core network 104a may also include a home location register (HLR) for maintaining “permanent” subscriber data and a visitor location register (VLR) (and/or a SGSN) for “temporarily” maintaining subscriber data retrieved from the HLR and up-to-date information on the location of mobile devices 102. In addition, cellular core network 104a may include Authentication, Authorization, and Accounting (AAA) that performs the role of authenticating, authorizing, and accounting for devices 102 operable to access cellular core network 104a.

PSTN 104b comprises a circuit-switched network that provides fixed telephone services. A circuit-switched network provides a dedicated, fixed amount of capacity (a “circuit”) between the two devices for the duration of a transmission session. In general, PSTN 104b may transmit voice, other audio, video, and data signals. In transmitting signals, PSTN 104b may use one or more of the following: telephones, key telephone systems, private branch exchange trunks, and certain data arrangements. Since PSTN 104b may be a collection of different telephone networks, portions of PSTN 104b may use different transmission media and/or compression techniques. Completion of a circuit in PSTN 104b between a call originator and a call receiver may require network signaling in the form of either dial pulses or multi-frequency tones.

IMS network 104c is a network that enables mobile communication technology to access IP based services. The IMS standard was introduced by the 3^{rd} generation partnership project (3GPP) which is the European 3^{rd} generation mobile communication standard. In general, the IMS standard discloses a method of receiving an IP based service through a wireless communication terminal such as mobile devices 102. To achieve these goals, IMS network 104c uses SIP and, in some embodiments, mobile device 102 is operable to use the same protocol when accessing services through broadband network 106b. Although not illustrated, IMS network 104c may include call session control function (CSCF), home subscriber server (HSS), application server (AS), and other elements. CSCF acts as a proxy and routes SIP messages to IMS network components such as AS. HSS typically functions as a data repository for subscriber profile information, such as type of services allowed for a subscriber. AS provides various services for users of IMS network 104c, such as, for example, video conferencing, in which case AS handles the audio and video synchronization and distribution to mobile devices 102.

Turning to access networks 106, access networks 106 include RAN 106a and broadband network 106b. RAN 106a provides a radio interface between mobile devices 102 and cellular core network 104a that may provide real-time voice, data, and multimedia services (e.g., a call) to mobile devices 102. In general, RAN 106a communicates air frames 112 via radio frequency (RF) links. In particular, RAN 106a converts between air frames 112 to physical link based messages for transmission through cellular core network 104a. RAN 106a may implement, for example, one of the following wireless interface standards during transmission: IS-54 (TDMA), Advanced Mobile Phone Service (AMPS), GSM standards, CDMA, Time Division Multiple Access (TDMA), General Packet Radio Service (GPRS), ENHANCED DATA rates for Global EVOLUTION (EDGE), or proprietary radio interfaces.

RAN 106a may include Base Stations (BS) 114 connected to Base Station Controllers (BSC) 116. BS 114 receives and transmits air frames 112 within a geographic region of RAN 106a called a cell and communicates with mobile devices 102 in the cell. Each BSC 116 is associated with one or more BS 114 and controls the associated BS 114. For example, BSC 116 may provide functions such as handover, cell configuration data, control of RF power levels or any other suitable functions for managing radio resource and routing signals to and from BS 114. MSC 110 handles access to BSC 116 and communication node 108, which may appear as a BSC 116 to MSC 110. MSC 110 may be connected to BSC 116 through a standard interface such as the A-interface.

Broadband network 106b facilitates communication between mobile devices 102 and communication node 108. In general, network 106b communicates IP packets to transfer voice, video, data, and other suitable information between network addresses. In the case of multimedia sessions, network 106b uses Voice over IP (VoIP) protocols to set up, route, and tear down calls. Network 106b may include one or more local area networks (LANs), metropolitan area networks (MANs), wide area networks (WANs), all or a portion of the global computer network known as the Internet, and/or any other communication system or systems at one or more locations. In the illustrated embodiment, IP network 106b includes SIP proxy servers 134 for routing SIP messages. Each SIP proxy server can be any software, hardware, and/or firmware operable to route SIP messages to other SIP proxies, gateways, SIP phones, communication node 108, and others.

In general, communication node 108 can include any software, hardware, and/or firmware operable to provide voice call continuity during handovers between legs using cellular radio technology and legs using broadband technology. For example, mobile device 102 may access core networks 104 either through RAN 106a or broadband network 106b. In this case, when mobile device 102 switches between these two access networks 106 during a call session, communication node 108 may provide continuity of a call session between mobile device 102 and core network 104 transparent to the participating core network 104. In other words, communication node 108 may switch between a call leg using a cellular radio technology (e.g., GSM) and a call leg using broadband technology (e.g., SIP). In general, a node may integrated and/or stand alone unit and, in addition, may be part of a rack or system. In some embodiments, communication node comprises a system. A system may be a single node, a plurality of nodes, a portion of one or more nodes. A system may be distributed and may cross network boundaries.

In some embodiments, communication node 108 locally manages handovers between access networks 106. Communication node 108 may be operable to receive a request from device 102 to generate a call session through an access network 106 and identify that device 102 as currently having a call session through the other access network 106. For example, communication node 102 may receive a request to establish a call session through cellular core network 106a and identify that mobile device 102 has an existing call session established through broadband network 106b. In this case, communication node 108 may manage authentication and resource assignment for establishing the call session through cellular core network 106a. After performing these steps, communication node 108 may terminate the call leg through broadband network 106b and connect the call leg through RAN 106a to the remaining portion of the existing call session. In doing so, communication node 108 may provide voice call continuity transparent to the core network 104 participating in the call session. In other words, communication node 108 may serve as an anchor such that call controls maintained by the core network 104 remain constant.

In managing different communication technologies, communication node 108 may convert between cellular and/or broadband technologies. For example, communication node 108 may receive a GSM request from mobile device 102 to access services from IMS network 104c. In this case, communication node 108 may convert the GSM request to a SIP request prior to transmitting the request to IMS network 104c. The conversion may include conversion between parameters of different communication technologies and/or bit conversion. In addition, communication node 108 may also be operable to convert other broadband messages such as SIP messages to cellular radio technology messages such as GSM messages. For example, communication node 108 may be receive a SIP request from mobile device 102 to access services from cellular core network 104a, and prior to transmitting the message to cellular core network 104a, communication node 108 may convert the SIP request to a GSM request.

Communication node 108 may, in one embodiment, emulate or otherwise represent itself as an element of core network 104. For example, communication node 108 may emulate or otherwise represent itself as a BSC, MSC, PCSCF (not illustrated) or other element of a core network 104. In the case that communication node 108 emulates a BSC, communication node 108 may be queried by MSC 110 in cellular core network 104a like any other BSC 116. In the case of communication node 108 emulating a MSC, communication node 108 may query BSC 116 and perform call management functions associated with MSCs (e.g., Mobility Management, Call Control, Services). In the case that communication node 108 emulates a PCSCF, communication node 108 may be queried by CSCF in IMS network 104c like any other PCSCF.

In one aspect of operation, mobile device 102b transmits a request for services from IMS network 104c. In response to at least the request, communication node 108 checks an associated VLR (not illustrated) to determine if mobile device 102 is registered. In the event that mobile device 102 is not registered, communication node 108 registers, authenticates, and provisions resources to establish a call leg through broadband network 104c. Communication node 108 may use SIP/RTP to establish the call leg. During the call section, mobile device 102 may periodically and/or in response to an event determine if mobile device 102 is within operating range of RAN 106a. In response to at least detecting RAN 106a, mobile device 102 may transmit a request to establish a call leg through RAN 116, which is transmitted to communication node 108 via cellular core network 104a. After determining that mobile device 102 is registered and authenticated, communication node 108 identifies that mobile device 102 has an existing call leg through broadband network 106b. Prior to terminating the call leg through broadband network 106b, communication node 108 provisions resources in cellular core network 104a and RAN 106a using, for example, GSM. After establishing the cellular call leg, communication node 108 terminates the broadband call leg and connects the cellular call leg to the remaining call session. In some embodiments, the handover between the broadband technology and the cellular communication technology is transparent to IMS network 104c.

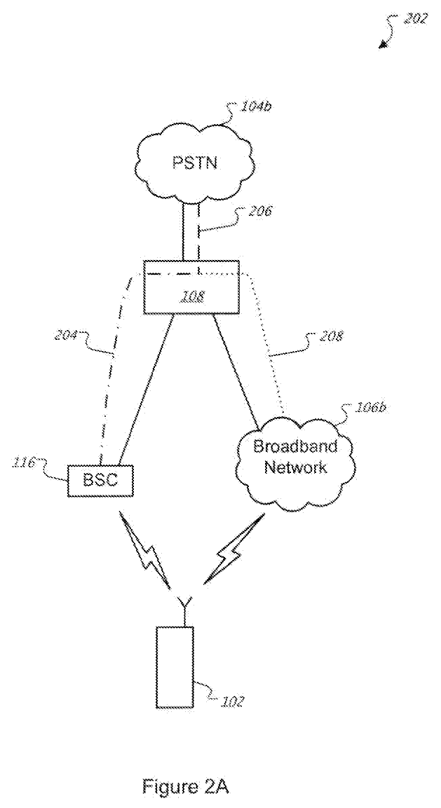

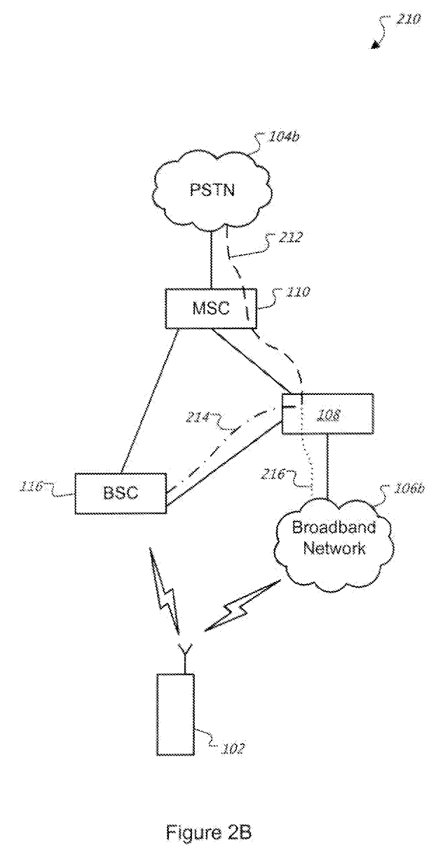

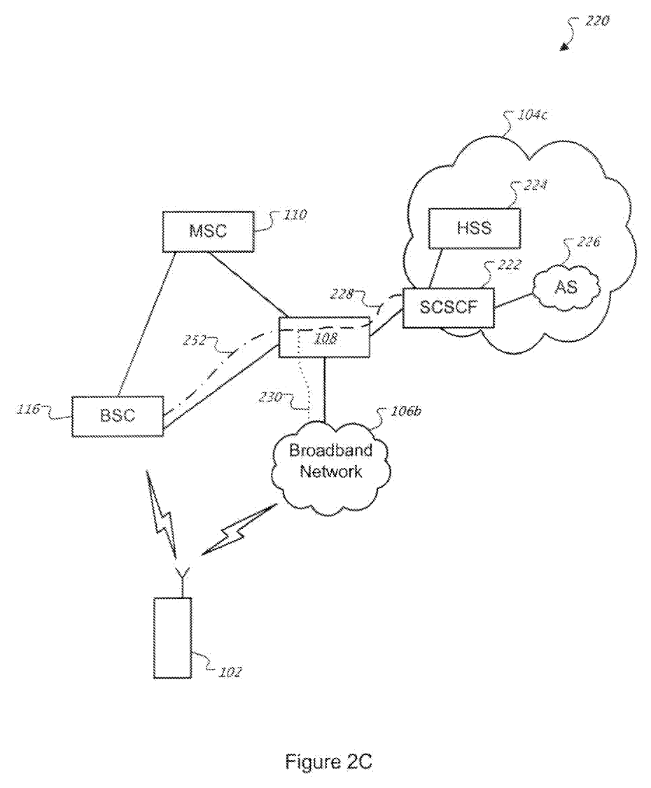

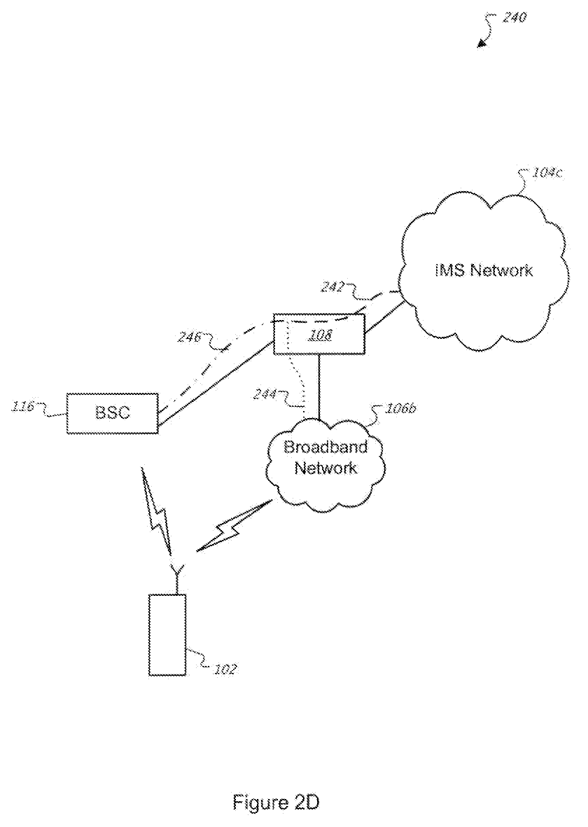

FIGS. 2A to 2D illustrate block diagrams of different implementations of communication node 108. For ease of reference, only some of the elements of communication system 100 of FIG. 1 are shown. The block diagrams of FIG. 2 are described with respect to system 100 of FIG. 1, but these scenarios could be used by any other system. Moreover, system 100 may use any other suitable implementations for providing voice call continuity during handovers between cellular radio technologies and broadband technologies.

Referring to FIG. 2A, system 202 includes a communication node 108 that emulates an MSC when managing handovers between different communication technologies. As such, communication node 108 may perform mobility management, call control, services, as well as the interaccess handover (handover between access networks 104). In one aspect of operation, an exisitng call session between mobile device 102 and PSTN 104b may include a cellular cal leg 204 and a call leg 206 between communication element 206 and PSTN 104b. In the response to at least mobile device 102 detecting broadband network 106b, mobile device 102 transmits a request to establish a call leg through broadband network 106b. The request is forward to communication node 108 for performing the management functions. In connection with these processes, communication node 108 allocates resources in broadband network 106b using SIP/RTP commands. After the broadband call leg 208 is established, communication node 108 terminates cellular call leg 204 and connects broadband call leg 208 with call leg 206 to maintain the call session. As a result, the handover between the different technologies may be transparent to PSTN 104b.

Referring to FIG. 2B, system 204 includes communication node 108 that emulates a BSC when managing handovers between different technologies. In one aspect of operation, mobile device 102 transmits a request to BSC 116 to establish a call session with PSTN 104b. Initially, BSC 116 forwards the request to communication node 108. In response to at least the request, communication node 108 determines whether mobile device 102 is a dual band wireless device. In the event that mobile device 102 is merely a cellular device, communication node 108 returns the request to BSC 116 which, in turn, forwards the request to MSC 110 for registration, authentication, and allocation of resources for the call session with PSTN 104b. In the event that mobile device 102 is a dual-band device, communication node 108 forwards the request to MSC 110 for managing the call session with the indication that communication node 108 is the BSC where mobile device 102 is located. In other words, MSC 110 manages call sessions for mobile device 102 except handovers between the different technologies is performed by communication node 108. In some embodiments, these handovers are independent of and/or transparent to MSC 110. An established call session established through RAN 106a may include call leg 212 and cellular call leg 214.

In the event that mobile device 102 identifies broadband network 106b, mobile device 102 may transmit a request to establish a call leg through broadband network 106b. In some embodiments, communication node 108 forwards the request to MSC 110 to perform initial management functions such as authentication. In response to at least the request, communication node 108 may establish broadband call leg 216. After establishing broadband call leg 216, communication node 108 may terminate cellular call leg 214 and connect broadband call leg 216 with the call leg 212 to maintain the call session. In some embodiments, communication node 108 performs this handover between the different technologies independent of MSC 110.

Referring to FIG. 2C, system 220 includes communication node 108 that present itself as a BSC to MSC 110 and a P-CSCF to IMS network 104c. In the illustrated embodiment, IMS network 104c includes a Serving CSCF (S-CSCF) 222, a Home Subscriber Server (HSS) 224, and Application Server (AS) 226. S-CSCF 222 is a SIP server that that manages call sessions in IMS network 104c. For example, S-CSCF 222 may perform one or more of the following: manage SIP registrations, forward messges received by IMS network 104c to the appropriate AS 226, and enforce network policies based, at least in part, on user profiles. When managing call sessions, S-CSCF 222 may download and upload user profiles from HSS 224. HSS 224 may comprise a database including user information to support the IMS network entities such as S-CSCF 222. For example, HSS 224 may include subscription-related information (user profiles), perform authentication and authorization of users, and provide information about the physical location of a user. AS 226 may provide services and/or interfaces with the S-CSCF 222 using SIP. Such services may include one or more of the following: Caller ID related services; Call waiting; Call forwarding; Call blocking services; Lawful interception; Announcement services; Conference call services; Voicemail, Text-to-speech, Speech-to-text; Location based services; or others.

In one aspect of operation, a call session between mobile device 102 and IMS network 104c may include call leg 228 and broadband call leg 230. In embodiments that mobile device 102 is a SIP-based phone, SIP messages are merely routed through communication node 108 without any modification or translation because IMS network 104c is a SIP based network. In the event that mobile phone detects RAN 106a, mobile device 102 may transmit a request to establish cellular call leg 232 to communication node 108. In this case, the request is forward to MSC 110 to authenticate mobile device 102 and provisions resources in cellular core network 104a and RAN 106a. After cellular call leg 232 is established, communication node 108 terminates broadband call leg 230 and connects cellular call leg 232 to call leg 228. In this case, communication node 108 may translate messages between the cellular radio technology associated with MSC 110 and SIP.

Referring to FIG. 2D, system 240 includes a communication node 108 that emulates both an MSC to cellular core network 104a and a P-CSCF to IMS network 104c. In one aspect of operation, a call session includes a call leg 242 and a broadband call leg 244. In the event that mobile device detects RAN 106a, mobile device 102 may transmit a request to establish a call leg through cellular core network 104a and RAN 106a. BSC 116 forwards this request to communication node 108 for processing. In this case, communication node 108 emulates an MSC and authenticates mobile device 102 and provisions resources for cellular call leg 246. After establishing cellular call leg 246, communication node 108 terminates broadband call leg 244 and connects cellular call leg 246 to call leg 242. In this case, communication node 108 may translate messages between a cellular radio technology such as GSM and SIP. Since communication node 108 emulates an MSC, mobile phone 102 may continue to roam within the cellular network and continue to receive IMS services.

FIG. 3 is an example system 300 for enabling handovers between GSM-based and SIP-based technologies. In particular, system 300 is a dual-band mobile device 102 of FIG. 1 in accordance with some embodiments of the present disclosure. At a high level, mobile device 102 includes a voice call continuity (VCC) module 302, a SIP client 304, a GSM module 306, and a WiFi module 308. These elements are for illustration purposes only. Mobile device 102 may include some, all, or different elements for enabling handovers between different communication technologies without departing from the scope of this disclosure.

As discussed above, mobile device 102 is operable to access core networks 104 through RAN 106a and broadband network 106b. Mobile device 102 may switch between these access networks 106 during a call session providing continuity to the call session. In addition, the handover between access networks 106 may be transparent to the user of mobile device 102. In some embodiments, VCC module 302 can include any software, hardware, and/or firmware operable to implement methods for providing GSM service (e.g., voice calls) over I-WLAN when mobile device 102 detects sufficient coverage. In some embodiments, VCC module 302 includes a 3GPP standard to support the GSM service over I-WLAN. In providing voice call continuity between a CS Domain and an I-WLAN, or other IP-CANs, mobile device 102 may reduce, eleiminate, or minimize the use GSM/UMTS radio resources. SIP client 304 can include any software, hardware, and/or firmware operable to implement SIP protocols. In some embodiment, SIP client 304 is solely a software module enabling easy distribution to 2G and 3G wireless devices. SIP client 304 may facilitate formation, modification and execution of communication sessions between mobile device 102 and elements in system 100. In addition, SIP client 304 may enable peer-to-peer communication and/or multipoint communication. In the event that a SIP session is being established with mobile device 102, SIP client 304 may determine information in accordance with the SIP protocol, a port and/or an IP address of the element in system 100 that mobile device 102 is establishing a call session with. GSM module 306 can include any software, hardware, and/or firmware operable to communication with a GSM network in accordance with GSM standards. WiFi module 308 can include any software, hardware, and/or firmware operable to communication with a WLAN network in accordance with Internet Engineering Task Force (IETF) standards.

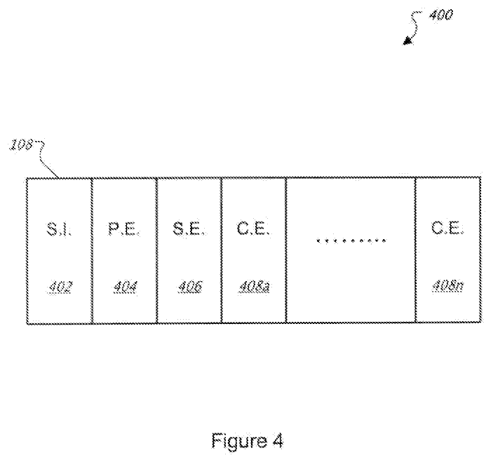

FIG. 4 illustrates an example system 400 for providing handovers between different communication technologies. In particular, system 400 is a communication node 108 for providing handovers between GSM-based technology and SIP-based technology. In some embodiments, communication node 108 includes Signaling Interface (SI) 402, Packet Engine (PE) 404, Switching Engine (SE) 406, and one or more Call Engines (CE) 408. These elements are for illustration purposes only. Mobile device 102 may include some, all, or different elements for providing handovers between different communication technologies without departing from the scope of this disclosure.

As discussed above, communication node 108 may provide call session continuity during handovers between different communication technologies such as GSM and SIP. In doing so, communication node 108 may enable mobile device 102 to maintain services from core networks 104 (e.g., PSTN 104b) while switching between different access networks 106. SI 402 can include any software, hardware, and/or firmware operable to provide an interface for connecting to an external SS7 network such as PSTN 104b. In this case, SI 402 processes messages between communication node 108 and PSTN 104b. After an SS7 message is received, PE 404 includes any software, ahrdware, and/or firmware operable to provide routing routing functionality of SS7 messages to other subsystems internal to communication node 108 such as CE 408. In routing to a CE 408, PE 404 may perform resource management functions to determine the various loads of the plurality of CE 408a through 408n. In addition, PE 404 may also perform interface functionality of SIP messaging as well as overall resource management. SE 406 may provide a switching fabric for intra-shelf (card-to-card) communications. Once a message has been routed to an appropriate CE 408, CE 408 includes any software, hardware, and/or firware operable to provide call processing functionality (e.g., CC, MM, signaling gateway, translation, services, VCC, Megaco, Interaccess HO).

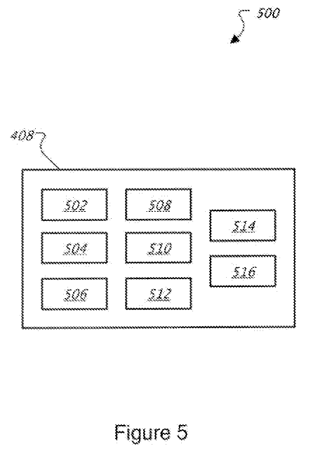

FIG. 5 illustrates an example system 500 for providing call processing functionality. In particular, system 500 is one embodiment of a CE 408 of FIG. 4 that includes providing call processing functionality during handover. In some embodiments, CE 408 includes a call control (CC) module 502, a mobility management (MM) module 504, a signaling gateway (SG) 506, a translation module 508, a services module 510, a voice call continuity (VCC) module 512, megaco module 514, and an intereaccess handover (HO) module 516. These modules are for illustration purposes only. Mobile device 102 may include some, all, or different modules for providing call control functionality without departing from the scope of this disclosure.

CC module 502 maintains a state of a call session in system 100. As discussed above, mobile device 102 may roam in system 100, so MM module 504 may provide mobility functionality for mobile device 102 such as location updates. SG 506 may provide processing, translation and interworking within signaling nodes of system 100. Translation module 508 may perform digit translation for a call session. Services module may 510 provide services requested for a call session including supplementary services. VCC module 510 may provide server functionality for voice call continuity function. Megaco module 512 may provide an interface with a media gateway. Interaccess HO module 514 may provide functionality for handovers between RAN 106a (e.g., GSM, UMTS) and broadband network 106b (e.g., SIP/WIFI).

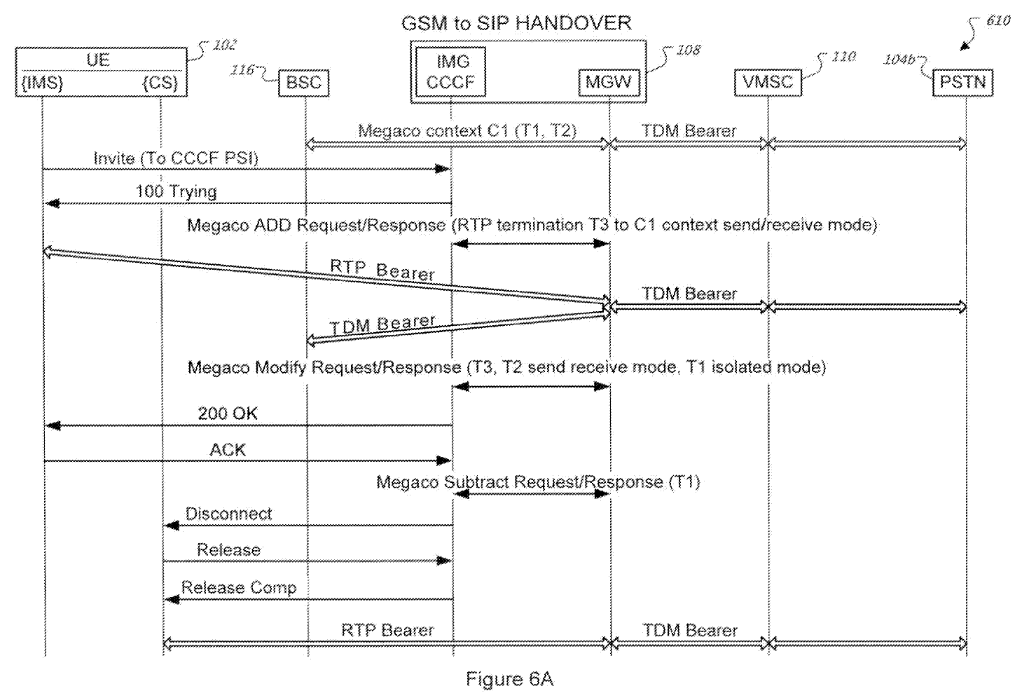

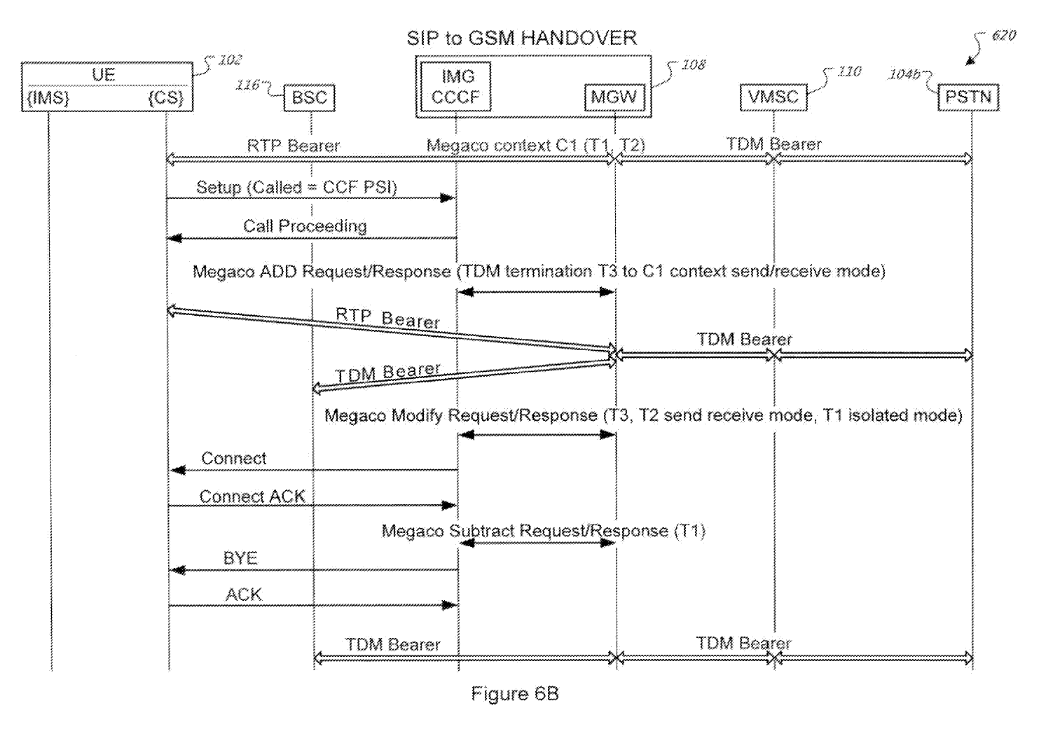

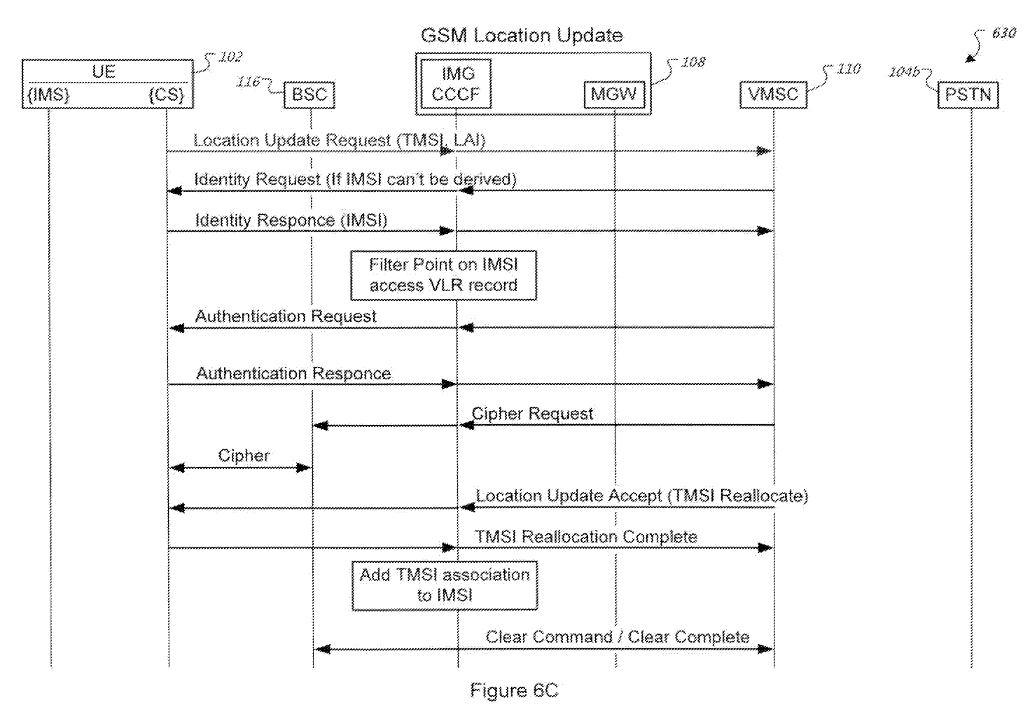

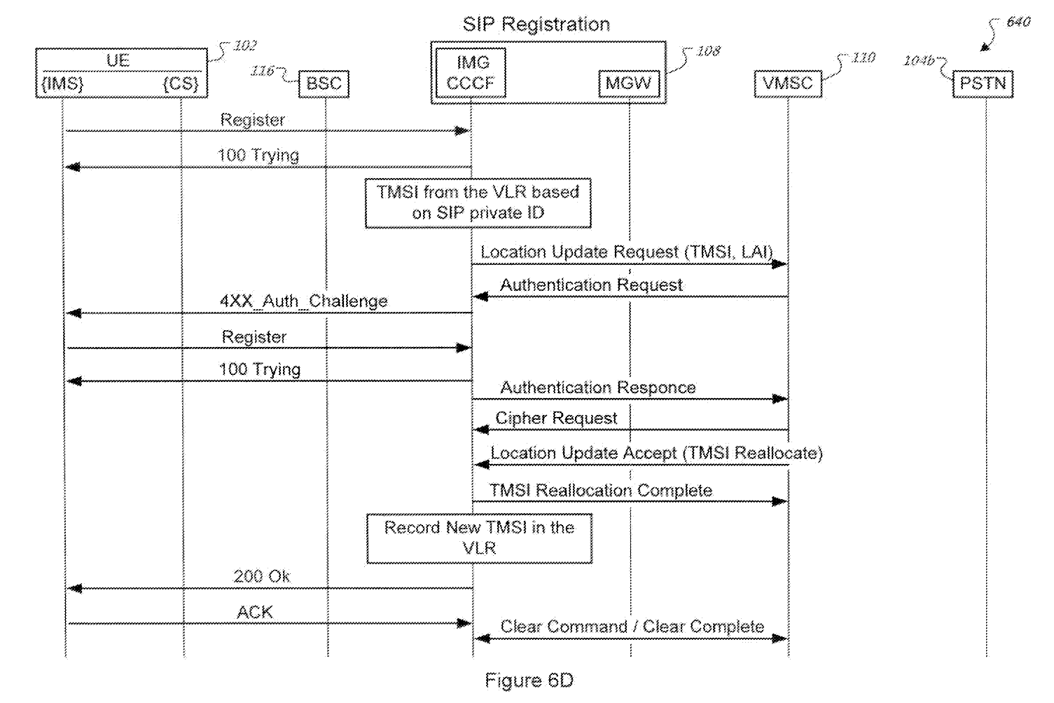

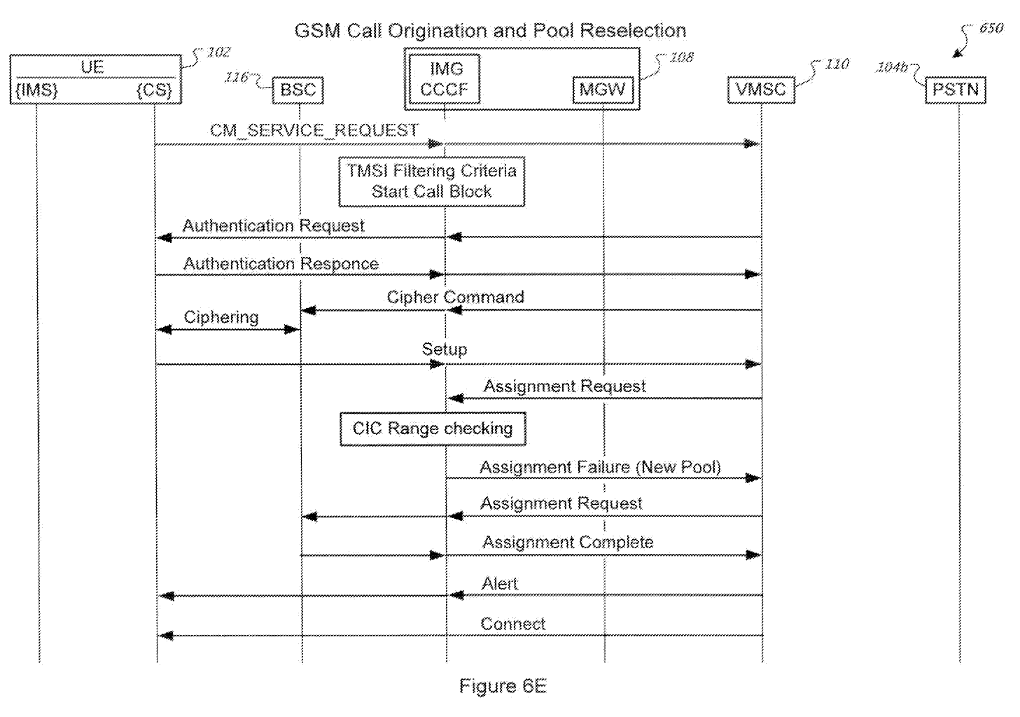

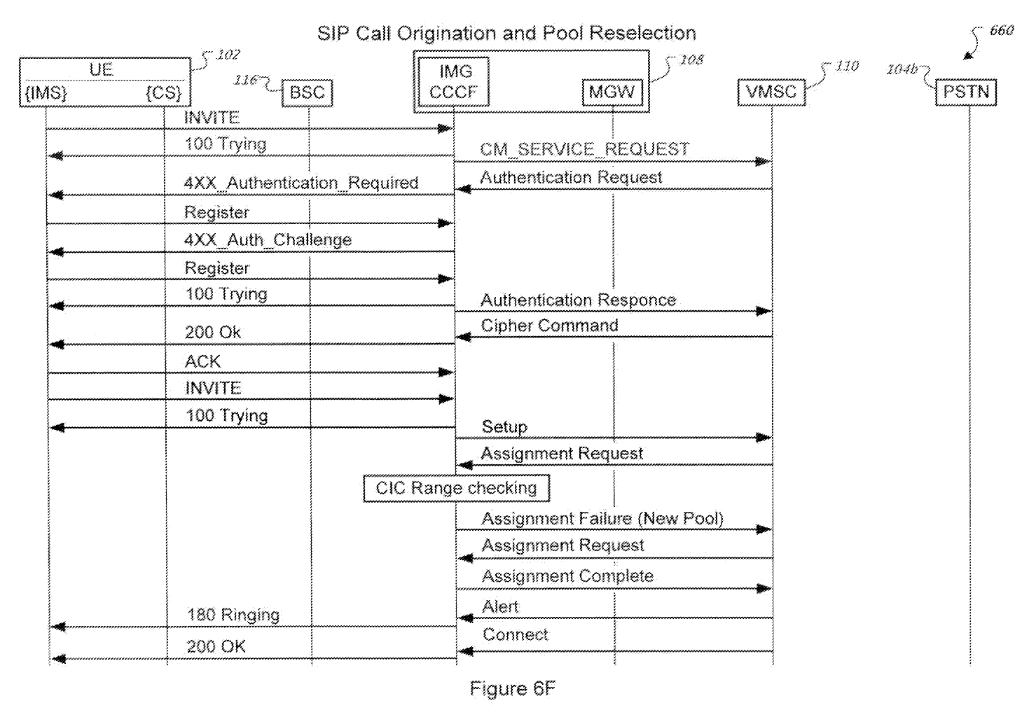

FIGS. 6A to 6F illustrate call flows in accordance with communication system 100 of FIG. 1. In particular, call flow 610 illustrates a GSM to SIP handover of mobile device 102. As discussed above, mobile device 102 may switch between accessing PSTN 104b through RAN 106a and broadband network 106b. Call flow 620 illustrates a SIP to GSM handover of mobile device 102. Call flow 630 illustrates a GSM location update of mobile device 102. Call flow 640 illustrates a SIP registration for mobile device 102. Call flow 650 illustrates a GSM call origination and pool reselection for mobile device 102. Call flow 660 illustrates a SIP call origination and pool reselection for mobile device 102. Call flows 610 to 660 are for illustration purposes only. System 100 may implement some, none, or all of the illustrated call flows. In addition, system 100 may implement some, none, or all of the steps illustrated in the call flows without departing from the scope of this disclosure.

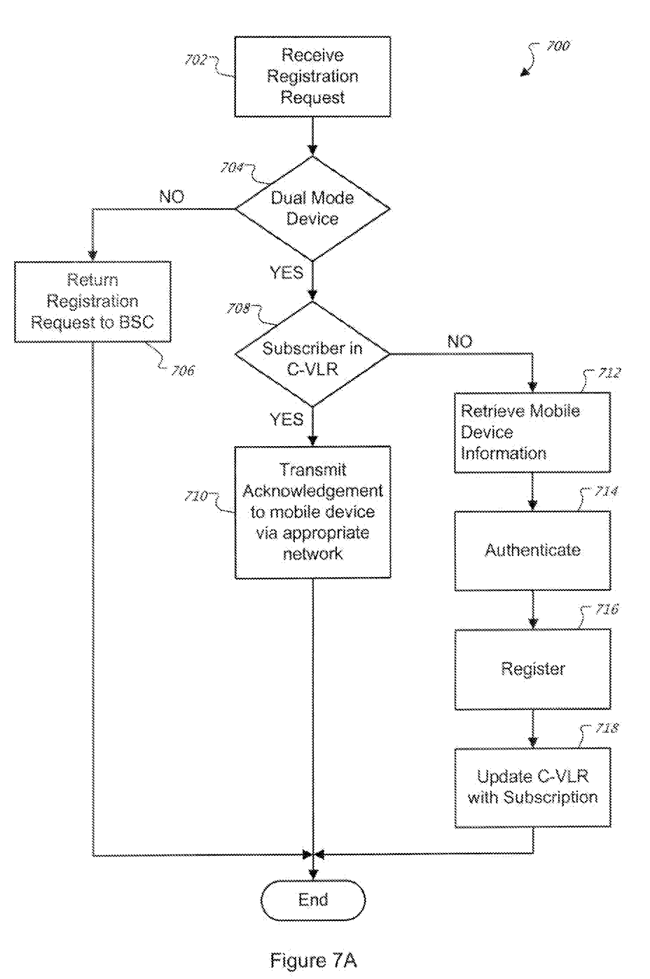

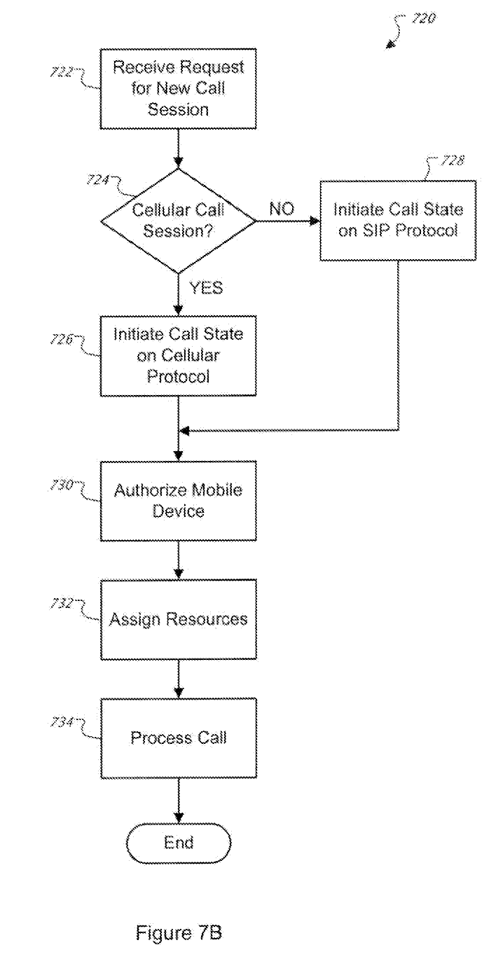

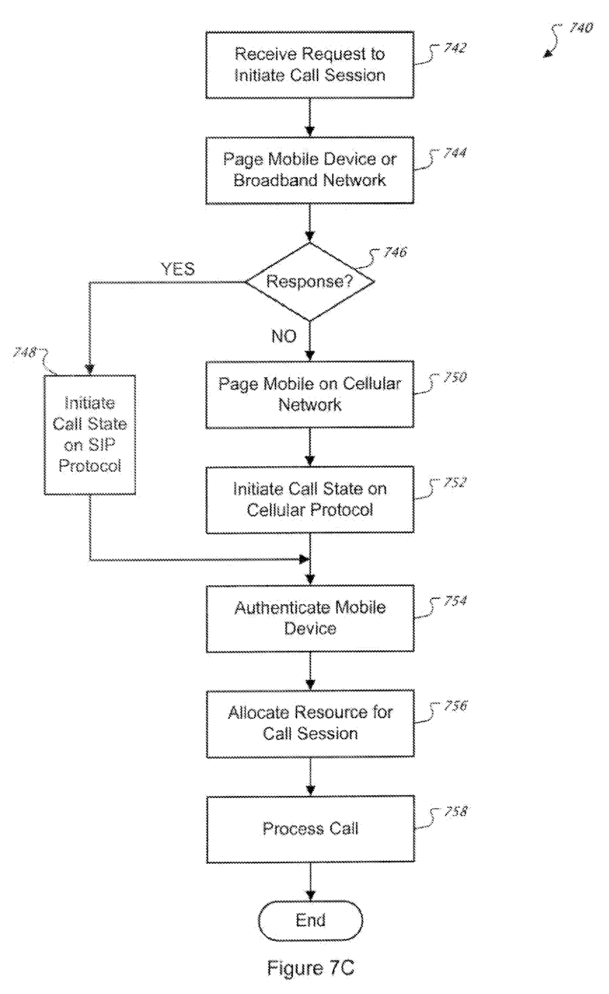

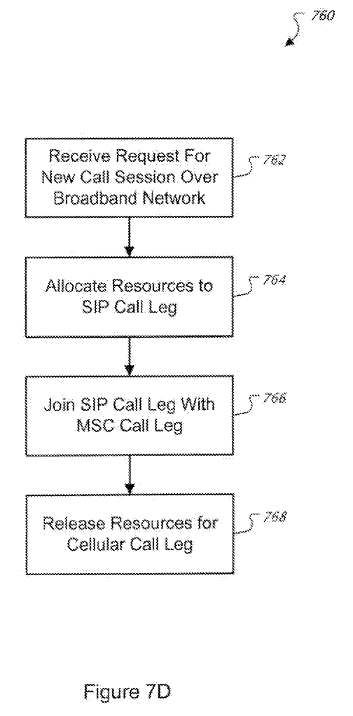

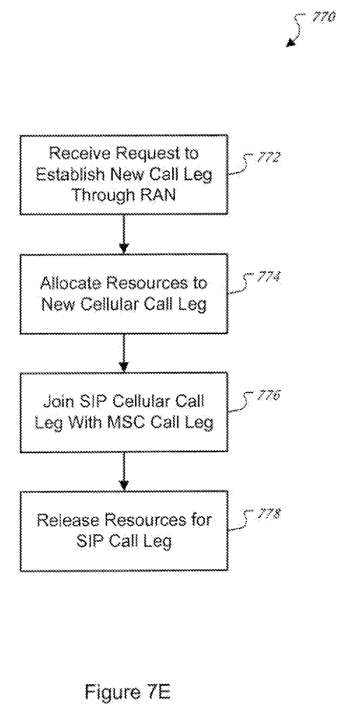

FIGS. 7A to 7E are flow diagrams illustrating example methods for managing calls using different communication technologies. The illustrated methods are described with respect to system 100 of FIG. 1, but these methods could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Referring to FIG. 7A, method 700 begins at decisional step 702 where communication node 108 receives a registration request from mobile device 102. If communication node 108 determines that mobile device is a single mode device at decisional step 704, then, at step 706, communication node 108 returns the registration request to the base station controller. If communication node 108 determines that mobile device is a double-mode device at decisional step 704, then execution proceeds to decisional step 708. If communication node 108 determines that mobile device is a subscriber in an associated C-VLR, then, at step 710, communication node 108 transmits an acknowledgement to mobile device via the appropriate access network 106. If communication node 108 determines that mobile device is not a subscriber in the C-VLR, then, at step 712, communication node 108 retrieves mobile device information (e.g., mobile identity, associated TMSI, IMSI, and SIP ID). At step 714, communication node 108 authenticates mobile device 102 and then, at step 716, registers mobile device 102 with the appropriate core network 104. Communication node 108 updates C-VLR with the subscriber.

Referring to FIG. 7B, method 720 begins at 722 where communication node 108 receives a request to start a new call session from mobile device 102. If communication node 108 determines mobile device 102 is requesting a cellular call session at decision step 724, then, at step 726, communication node 108 initiates a call state using cellular protocol. If communication node 108 determines mobile device 102 is requesting a SIP call session at decision step 724, then, at step 728, communication node 108 initiates a call state using SIP. At step 730, communication node 108 authenticates mobile device 102 and, at step 732, allocates resources for the new call session in accordance with the type of call. Communication node 108 processes the new call session at step 734.

Referring to FIG. 7C, method 740 begins at step 742 where communication node 108 receives a request to initiate a call with mobile device 102. In response to at least the request, communication node 108 pages broadband network 106b at step 744. If communication node 108 receives a response from mobile device 102 at decisional step 746, then, at step 748, communication node 108 initiates a call state using SIP. If communication node 108 does not receive a response from mobile device 102 at decisional step 746, then, at step 750, communication node 108 pages mobile device 102 in RAN 106a. Communication node 108 initiates a call state using a cellular protocol such as GSM at step 752. At step 754, communication node 108 authenticates mobile device 102 and, at step 756, allocates resources for the new call session in accordance with the type of call. Communication node 108 processes the new call session at step 758.

Referring to FIG. 7D, method 760 begins at step 762 where communication node 108 receives a request to start a new call session over broadband network 762. At step 764, communication node 108 allocates resources to a new SIP call leg through broadband network 106b. After establishing the SIP call leg, communication node 108 connects the SIP call leg with the MSC call leg at step 766. Communication node 108 releases resources with the cellular call leg at step 768.

Referring to FIG. 7E, method 770 begins at step 772 where communication node 108 receives a request to start a new call session over RAN 106a. At step 774, communication node 108 allocates resources to a new cellular call leg through RAN 106a. After establishing the cellular call leg, communication node 108 connects the cellular call leg with the MSC call leg at step 776. Communication node 108 releases resources with the SIP call leg at step 778.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A communications network, comprising:
a network plane including a core network;
an access plane including a radio access network (RAN) and a broadband network;
a node at an edge of the access plane, the node operable to provide inter-access handover between a cellular technology and a broadband technology for data sessions with multi-mode mobile devices.

2. The communications network of claim 1, wherein the node is in the access plane.

3. The communications network of claim 1, wherein the node is in the network plane.

4. The communications network of claim 1, the node configured to track a subscriber associated with the multi-mode mobile devices communicating with the node over the RAN and the broadband network.

5. The communications network of claim 1, wherein the cellular technology comprises global system for mobile communication (GSM).

6. The communications network of claim 1, wherein the cellular technology comprises Universal Mobile Telecommunications System (UMTS).

7. The communications network of claim 1, wherein the broadband technology comprises session initiation protocol (SIP).

8. The communications network of claim 1, the node operable to provide IP multimedia subsystem (IMS) services to the multi-mode mobile devices across the RAN and the broadband network.

9. A communications network, comprising:
a node configured to provide inter-access handover between a cellular technology and a broadband technology for multi-mode mobile devices; and
the node configured to provide IP multimedia subsystem (IMS) services to the for multi-mode mobile devices over a cellular network using the cellular technology and the broadband network using a broadband technology.

10. The communications network of claim 9, wherein the cellular technology comprises global system for mobile communication (GSM).

11. The communication network of claim 9, wherein the cellular technology comprises Universal Mobile Telecommunications System (UMTS).

12. The communications network of claim 9, wherein the broadband technology comprises session initiation protocol (SIP).

13. A communications network, comprising:
a node configured to provide inter-access handover between a cellular technology and a broadband technology for data session with a multi-mode mobile device; and
the node configured to communicate with the multi-mode mobile devices over a broadband network using session initiation protocol (SIP).

14. The communications network of claim 13, wherein the cellular technology comprises global system for mobile communication (GSM).

15. The communications network of claim 13, wherein the cellular technology comprises Universal Mobile Telecommunications System (UMTS).

16. A communications network, comprising:
a node configured to provide inter-access handover between a cellular technology and a broadband technology for data sessions with multi-mode mobile devices; and
the node configured to track subscribers associated with the multi-mode mobile devices communicating with the node over a cellular network using the cellular technology and a broadband network using the broadband technology.

17. The communications network of claim 16, wherein the cellular technology comprises global system for mobile communication (GSM).

18. The communications network of claim 16, wherein the cellular technology comprises Universal Mobile Telecommunications System (UMTS).

19. The communications network of claim 16, wherein the broadband technology comprises session initiation protocol (SIP).

20. A communications network, comprising:
a node configured to provide inter-access handover between a cellular technology and a broadband technology for data sessions; and
the node configured to provide IP multimedia subsystem (IMS) services in data sessions to mobile devices.

21. The communications network of claim 20, wherein the cellular technology comprises global system for mobile communication (GSM).

22. The communications network of claim 20, wherein the cellular technology comprises Universal Mobile Telecommunications System (UMTS).

23. The communications network of claim 20, wherein the broadband technology comprises session initiation protocol (SIP).

24. A communications network, comprising:
core network;
an access network comprising a broadband network and a radio access network (RAN) having a plurality of base station controllers (BSC);
a node connecting the BSCs of the RAN and the broadband network to the core network; and
the node configured to provide call control, mobility management, voice call continuity (VCC), and inter-access handover for data sessions over the access network with multi-mode mobile devices.

25. The communications network of claim 24, wherein the multi-mode mobile devices comprise cellular technology for communicating over a cellular network and broadband technology for communicating over a broadband network.

26. The communications network of claim 25, wherein the cellular technology comprises global system for mobile communication (GSM).

27. The communications network of claim 25, wherein the cellular technology comprises Universal Mobile Telecommunications System (UMTS).

28. The communications network of claim 25, wherein the broadband technology comprises session initiation protocol (SIP).

29. The communications network of claim 24, the node configured to function in the RAN in place of a cellular mobile switching center (MSC).

30. The communications network of claim 24, wherein the RAN does not include a mobile switching center (MSC) connecting the BSCs and the node.

31. The communications network of claim 24, further comprising an IP multimedia subsystems (IMS) network coupled to the node, the node operable to provide IMS services to multi-mode mobile devices over at least one of the RAN and the broadband network.

32. The communications network of claim 24, the node operable to provide IMS services to multi-mode mobile devices over the RAN and the broadband network.

33. A communications network, comprising:
a core network;
an access network including a broadband network and a radio access network having a plurality of base station controller (BSCs) and at least one mobile switching center (MSC);
a node connecting the broadband network to the core network; and
the node configured to provide inter-access handover for data sessions with multi-mode mobile devices over the access network.

34. The communications network of claim 33, the multi-mode mobile devices comprising cellular technology for communicating over a cellular network and broadband technology for communicating over a broadband network.

35. The communications network of claim 33, wherein the cellular technology comprises global system for mobile communication (GSM).

36. The communications network of claim 33, wherein the cellular technology comprises Universal Mobile Telecommunications System (UMTS).

37. The communications network of claim 33, wherein the broadband technology comprises session initiation protocol (SIP).

38. The communications network of claim 33, the node operable to provide IP multimedia system (IMS) services to the mobile devices over the access network.

39. The communications network of claim 38, wherein at least one of the mobile devices if a non-IMS mobile device.

40. A mobile switching center, comprising:
a communication module operable to communication with a multi-mode mobile device;
an inter-access handover module configured to handover a communication session with a multi-mode mobile device operable to switch between GSM and SIP in response to at least the mobile device switching between a GSM network and an IP network;
a call control module, a mobility management module, and a translation module;
an IMS module operable to provide IMS services to the multi-mode mobile device through the GSM network and the IP network; and wherein the mobile switching center is located at an access edge.
